(19) United States
(12) Patent Application Publication
(10) Pub. No.: US 2026/0213914 A1
(43) Pub. Date: Jul. 23, 2026

(54) METHOD FOR SYNCHRONIZING LIGHT BEAMS IN THE DETECTION OF VERY WEAK OPTICAL SIGNALS CARRYING CLASSICAL OR QUANTUM INFORMATION

(71) Applicant: QUANTUM OPTICAL TECHNOLOGIES SP. Z O.O., Rzeszów (PL)

(72) Inventors: Michal JACHURA, Warszawa (PL); Marcin JARZYNA, Warszawa (PL); Lidia TANSKA, Warszawa (PL)

(21) Appl. No.: 19/140,388

(22) PCT Filed: Dec. 27, 2023
(86) PCT No.: PCT/PL2023/050108

§ 371 Date: Jun. 18, 2025

(30) Foreign Application Priority Data
Dec. 29, 2022 (PL) 443327

(51) Int. Cl. H04L 7/00; H04B 10/70

(52) U.S. Cl. CPC H04L 7/0075; H04B 10/70

(57) ABSTRACT

The subject of invention is a method for synchronizing optical beams in the detection of very weak optical signals carrying classical or quantum information, based on quantum pulse gating implemented using a nonlinear optical medium. It is characterized in that the lower frequency optical beam leaving the nonlinear medium is monitored by a photodetector connected to an electronic module, which controls the optical delay line placed in the optical path of the control beam or the signal beam in such a way that the value of the time-averaged optical signal measured by the photodetector is as small as possible, while the correction of the delay line based on the measured signal occurs continuously or periodically. The higher frequency optical beam leaving the nonlinear medium is measured using an optical signal receiver capable of detecting the optical signal modulated in the modulation format of the transmitter generating the signal beam pulses.

### TECHNICAL FIELD

The subject of the invention is a method for synchronizing optical beams in the detection of very weak optical signals, based on quantum pulse gating. This method can be used when the signal beam and the control beam do not originate from the same light source or are not controlled using the same electronic system. Similarly, this method can be applied when one of the beams comes from a distant light source and propagates through a temporally unstable medium such as the Earth's atmosphere or an optical fiber being a part of an underground or above-ground cable. The invention can be applied in satellite communication, telecommunications, optics, and transmitting weak optical signals over large distances, such as deep space.

### BACKGROUND ART

In the state of the art there is a method of quantum pulse gating first proposed in the work [A. Eckstein, B. Brecht, and C. Silberhorn, “A quantum pulse gate based on spectrally engineered sum frequency generation,” Opt. Express 19, 13770-13778 (2011)]. This method relies on the suitable engineering of the three-wave mixing of in a nonlinear crystal or nonlinear waveguide. Two light beams with frequencies ω₁ and (ω₂ are coupled into the nonlinear medium. The signal beam of frequency ω₁ consists of many temporal-spectral modes of the electromagnetic field, while the control beam of frequency ω₂ propagates in a selected single temporal-spectral mode of the electro-magnetic field. Inside the nonlinear medium, the three-wave mixing occurs. After the propagation the output beam of higher frequency (ω₁+ω₂ propagates in a single temporal-spectral mode determined by the control beam, and the output beam of lower frequency consists of the remaining temporal-spectral modes of the signal beam. This method is helpful in detecting very weak optical signals for two reasons. First, the information encoded in the signal beam can be detected using light detectors at frequency (ω₁+ω₂, often corresponding to the wavelength shift from infrared light to the visible range, where single-photon detectors have better quantum efficiency and much lower dark count rates. Secondly, due to the modal selectivity of the nonlinear process, the light beam at higher frequency (ω₁+ω₂ contains exclusively the noise associated with a single temporal-spectral mode (as opposed to the multimodal noise in the signal beam), which significantly increases the signal-to-noise ratio during detection. Due to the theoretical nature of the work, no solution was proposed for the problem of temporal synchronization of the signal and control beams in the nonlinear medium.

The work [Dileep V. Reddy and Michael G. Raymer, “Engineering temporal-mode-selective frequency conversion in nonlinear optical waveguides: from theory to experiment,” Opt. Express 25, 12952-12966 (2017)] presents an experimental implementation of quantum pulse gating in a nonlinear waveguide MgO:LN. The engineering of the modal shape of the signal and control beams is carried out using a 4f system, diffraction gratings, and a spatial phase modulator. The authors demonstrate high gating efficiency (>80%) for the control beam in the first or second temporal-spectral mode in the Gauss-Hermite HG0 or HG1 basis. Temporal synchronization of the control and signal beams is maintained by using a single light source (a titanium-sapphire oscillator) for the generation of both beams.

In the patent document [U.S. Pat. No. 10,871,699B2], a method for demultiplexing temporal-spectral modes based on quantum pulse gating in an optical resonant cavity is presented. Both the signal beam and the control beam are coupled into an optical resonant cavity made of a nonlinear medium. Inside the cavity, sum frequency generation occurs involving the temporal-spectral mode of the control beam and a selected temporal-spectral mode of the signal beam. After frequency conversion, the mode selected by the control beam remains in the cavity, while the remaining temporal-spectral modes of the signal beam leave the cavity. Thanks to the high Q-factor of the cavity, the resonator can be used as an optical register introducing controlled time delay into the optical signal. Temporal synchronization of the control and signal beams is provided by using a single electronic system controlling both beams.

The publication [Amin Shahverdi, Yong Meng Sua, Ivan Dickson, Malvika Garikapati, and Yu-Ping Huang, “Mode selective up-conversion detection for LIDAR applications,” Opt. Express 26, 15914-15923 (2018)] describes the use of quantum pulse gating in LIDAR technology (light detection and ranging). In the proposed solution, the measurement of the distance to the studied objects is carried out using a laser beam with a central wavelength in the near-infrared range (from 1 μm to 2 μm). Operating in this spectral range is beneficial thanks to much lower solar light background in comparison with the operation in the visible light. Near-infrared laser light is also much safer for the human eye than visible laser light. Unfortunately, avalanche photodiodes capable of detecting infrared light, usually based on indium gallium arsenide (InGaAs), have a very high dark count rate. To solve this problem, the authors use quantum optical gating to convert the light reflected from the studied object to visible light just before the detection stage, allowing for the later use of silicon-based single-photon detectors. Temporal synchronization of the control and signal beams is provided by using a single light source (a fiber optic oscillator) for both beams.

In the work [Paritosh Manurkar, Nitin Jain, Michael Silver, Yu-Ping Huang, Carsten Langrock, Martin M. Fejer, Prem Kumar, and Gregory S. Kanter, “Multidimensional mode-separable frequency conversion for high-speed quantum communication,” Optica 3, 1300-1307 (2016)], the use of quantum optical gating for quantum communication is proposed. Communication is carried out using an alphabet composed of quantum states in a four-dimensional Hilbert space, the basis vectors of which are four temporal-spectral modes of a single photon (Gauss-Hermite modes). Quantum optical gating allows for selective projective measurements onto individual basis vectors, as well as projective measurements onto any superposition of basis states modes. The authors present the experimental implementation of the protocol using attenuated coherent states, showing very high gating efficiency (>90%) and high modal selectivity (>80%). Temporal synchronization of the control and signal beams in the experiment is provided by using a single light source (a fiber optics oscillator) for both beams.

### SUMMARY OF INVENTION

The essence of the invention is a method characterized in that the beam of lower optical frequency leaving the nonlinear medium is monitored by a photodetector connected to an electronic module, which controls an optical delay line placed in the optical path of the control beam or signal beam in such a way that the value of the time-averaged optical signal measured by the photodetector is as small as possible, with the correction of the delay line based on the measured signal occurring in a continuous or periodic manner, while the beam of higher optical frequency leaving the nonlinear medium is measured using an optical signal receiver enabling the detection of the optically modulated signal according to the modulation format of the transmitter generating signal beam pulses.

Preferably, the photodetector monitoring the beam of lower optical frequency leaving the nonlinear medium is a photodiode or a single-photon detector.

Preferably, the optical carrier wavelength of the signal beam is in the range of 700 nm-1600 nm.

Preferably, the signal beam is modulated in the PPM or OOK format.

Preferably, the signal beam consists of single photons transmitted in a superposition of temporal-spectral or polarization modes.

Preferably, the control beam consists of a sequence of pulses in a selected temporal-spectral mode.

Preferably, the time-scale for averaging the optical signal measured by the photodetector placed in the beam of lower optical frequency leaving the nonlinear medium ranges from 1 ns to 1 s.

### Technical Problem

The problem from the state of the art is the synchronization of light beams in quantum pulse gating when the signal beam and the control beam do not originate from the same light source or when they are not controlled using the same electronic system. Similarly, the problem from the state of the art is the synchronization of input beams in quantum pulse gating when one of the input beams comes from a distant source (e.g., a space probe) and propagates in a temporally unstable medium such as the Earth's atmosphere or an optical fiber being part of an underground or above-ground cable. Therefore, the aim of the invention is to develop a method for synchronizing light beams in the detection of very weak optical signals carrying classical or quantum information.

### Solution to Problem

The invention described in this patent application relies on the temporal synchronization of the control beam and the signal beam in quantum optical gating by monitoring one of the output beams of lower optical frequency using a photodetector. The photodetector measures the time-averaged power of the optical signal and sends the measured value to the electronic module. The electronic module modifies the setting of the optical delay line placed in the optical path of the control beam or signal beam so that the signal measured by the photodetector is as small as possible. In the event of desynchronization, the modal matching of the control beam and signal beam in the nonlinear medium decreases, causing a decrease in the power of the output beam of higher optical frequency and an increase in the power of the output beam of lower optical frequency. Minimizing the signal power measured using a detector placed in the output beam of lower optical frequency thus allows maintaining synchronization.

### Advantageous Effects of Invention

The state-of-the-art quantum gate pulsing described in in this patent application allows for mode-selective optical measurements, thereby significantly facilitating the detection of weak optical signals through increased signal-to-noise ratio. This invention enables the synchronization of input beams in quantum pulse gating when the exact arrival time of the signal or control beam pulses is unknown. This situation occurs when the control and signal beams do not originate from a single light source or are not controlled by a single electronic system. Such a situation also occurs, for example, when one of the input beams originates from a distant source (e.g., a space probe) and propagates through a temporally unstable medium such as the Earth's atmosphere or a fiber optic cable being a part of an underground or above-ground network.

### BRIEF DESCRIPTION OF DRAWINGS

The invention will be presented in more detail, in a preferred embodiments, with reference to the attached drawing in which:

FIG. 1 illustrates the principle of quantum optical gating for detecting very weak optical signals consisting of a sequence of pulses and the method of synchronizing the signal and control beams propagating in a nonlinear medium.

FIG. 2 illustrates the principle of quantum optical gating for detecting very weak optical signals modulated in the PPM (pulse position modulation) format and the method of synchronizing the signal and control beams propagating in a nonlinear medium.

FIG. 3 illustrates the principle of quantum optical gating for detecting very weak optical signals modulated in the OOK (on-off keying) format and the method of synchronizing the signal and control beams propagating in a nonlinear medium.

FIG. 4 illustrates the principle of quantum optical gating for detecting very weak optical signals carrying quantum information in the form of time-encoded qubits and the method of synchronizing the signal and control beams propagating in a nonlinear medium.

### DESCRIPTION OF EMBODIMENTS

The drawing uses symbols consistent with definitions from the glossary.

The terms used in the present description have the following meaning, as described in the definitions below. Other terms non-defined herein have the meaning as established and understood by a person skilled in the art in the light of his/her best knowledge, of the present disclosure, and of the context of the patent application description. Unless otherwise stated, the following term conventions used in this description have the meanings indicated in the definitions below.

The term “optical signal” means an electromagnetic field at optical frequencies which intensity changes over time.

The term “very weak optical signal” means an optical signal composed of pulses with total pulse energy comparable to or lower than the energy of a single photon at the carrier wavelength of that signal. For example, for a carrier wavelength of 1550 nm, the energy of a single photon is 0.8 eV, while for a carrier wavelength of 800 nm, the energy of a single photon is 1.55 eV. In particular, a very weak optical signal also means a single photon in a superposition of many temporal-spectral or polarization modes.

The term “temporal-spectral mode” means a time-dependent function describing the temporal intensity profile of the electromagnetic field in the optical signal. According to the theory of electrodynamics, any optical signal can be represented as a super-position of temporal-spectral modes with appropriate complex coefficients. An example of such set of modes is a set of Gauss-Hermite modes.

The term “quantum optical gating—QPG” means a technique for nonlinear conversion of optical signals, in which two light beams at frequencies ω₁ and ω₂ are introduced into a nonlinear medium, with the signal beam at frequency ω₁ consisting of many temporal-spectral modes of the electromagnetic field, and the control beam at frequency ω₂ being in a selected single temporal-spectral mode of the electromagnetic field. Inside the nonlinear medium, the three-wave mixing occurs, where the beam at frequency ω₁+ω₂ leaving the medium is in a single temporal-spectral mode determined by the control pulse mode, while the beam of lower frequency leaving the medium contains the remaining temporal-spectral modes of the signal beam.

The term “signal beam” means a light beam participating in quantum optical gating, which comes from the transmitter and cannot be controlled by the signal receiver.

The term “control beam” means a light beam participating in quantum optical gating whose temporal-spectral properties can be controlled by the signal receiver.

The term “OOK” (abbreviation for On-Off keying) refers to a form of digital modulation representing digital data as the presence or absence of a carrier wave. In its simplest form, the presence of a carrier wave for a specified time represents a binary one, while its absence of the carrier wave for the same period represents a binary zero.

The term “PPM” (abbreviation for pulse-position modulation) refers to a modulation format that encodes information in the temporal position of a pulse.

The term “photodetector” means an optoelectronic device capable of converting an optical signal into an electronic signal (e.g., a photodiode or single-photon detector).

The term “receiver” means an optoelectronic device capable of detecting an optical signal modulated in the modulation format of the transmitter generating the signal beam.

The term “electronic module” means a microprocessor, FPGA circuit, or PID controller capable of controlling an optical delay line based on the provided error signal.

The term “optical delay line” means an optical system that allows for controlled time delay in an optical signal.

The term “time-encoded qubit” means a method of encoding quantum information in which a single quantum information qubit is encoded using a single photon in a super-position of two temporal-spectral modes.

The term ‘optical carrier wavelength’ refers to the wavelength of the electromagnetic signal λ related to the optical frequency ω by the formula λ=2π/ω.

The term ‘lower frequency optical beam leaving the nonlinear medium’ refers to a beam of lower optical frequency leaving the nonlinear medium which at the same time is not the control beam.

The following embodiments are presented only in order to illustrate the invention and explain its individual aspects, and not for its limitation, and they should not be associated with its entire scope which is defined in the appended claims.

### EXAMPLES

### Example 1

### Synchronization of the Signal Beam and Control Beam in the Detection of a Sequence of Very Weak Optical Pulses Based on Quantum Pulse Gating

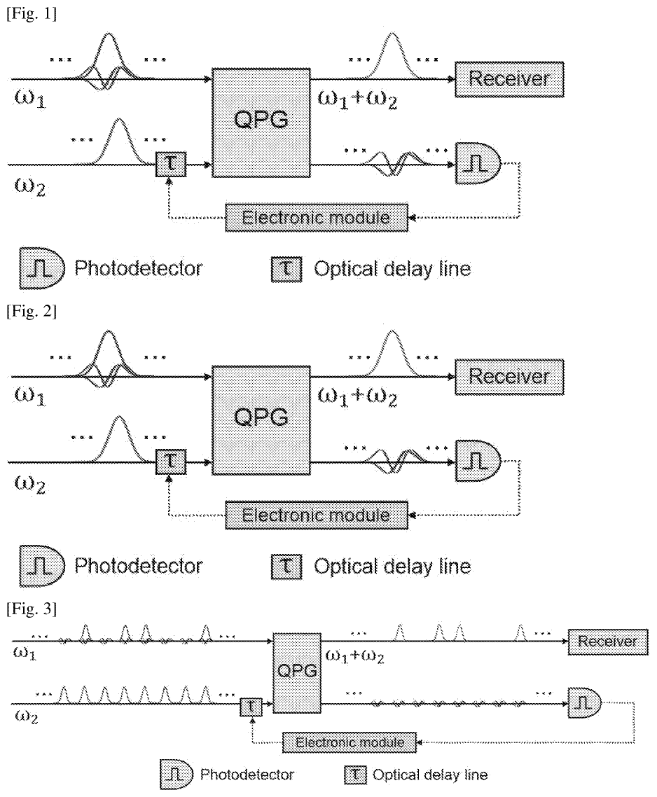

In the example shown in FIG. 1, light pulses at frequency ω₁ (signal beam pulses) in multiple temporal-spectral modes are introduced into a nonlinear medium along with light pulses at frequency ω₂ (control beam pulses) in a selected single temporal-spectral mode. The length of the optical carrier wave of the signal beam derived from frequency ω₁ is within the range of 700 nm-1600 nm. Inside the nonlinear medium, the three-wave mixing occurs, where the pulses at the optical frequency ω₁+ω₂ leaving the medium are in a single temporal-spectral mode determined by the mode of the control pulses, while the light beam at the lower frequency leaving the medium contains the remaining temporal-spectral modes of the signal pulses. The output pulses of higher optical frequency are measured by a receiver capable of detecting an optical signal modulated in the modulation format implemented in the transmitter generating the signal beam pulses. The output pulses of lower optical frequency are monitored by a photodetector connected to an electronic module. The photodetector measures the time-averaged power of the optical signal and sends the measured value to the electronic module. The electronic module adjusts the settings of the optical delay line located in the optical path of the control beam or the signal beam so that the signal measured by the photodetector is as small as possible. This ensures temporal synchronization between the signal beam and the control beam.

### Example 2

Synchronization of the Signal Beam and Control Beam in the Detection of a Very Weak Optical Signal Modulated in the PPM Format Based on Quantum Pulse Gating

In the example shown in [FIG. 2], light pulses at frequency ω₁ (signal beam pulses) modulated in the PPM modulation format and in many temporal-spectral modes are introduced into a nonlinear medium along with light pulses at frequency ω₂ (control beam pulses) in a selected single temporal-spectral mode. The control beam consists of a sequence of pulses in the selected temporal-spectral mode. The length of the optical carrier wave of the signal beam derived from frequency ω₁ is in the range of 700 nm- 1600 nm. Inside the nonlinear medium, the three-wave mixing occurs, where the pulses at frequency ω₁+ω₂ leaving the medium are in a single temporal-spectral mode determined by the mode of the control pulses, while the light beam of lower frequency leaving the medium contains the remaining temporal-spectral modes of the signal pulses. The output pulses of higher optical frequency are measured by a receiver adapted to detect optical signals modulated in the PPM format. The output pulses of lower optical frequency are monitored by a photodetector connected to an electronic module. The photodetector measures the time-averaged power of the optical signal and sends the measured value to the electronic module. The averaging time of the optical signal measured by the photodetector placed in the beam of lower optical frequency leaving the nonlinear medium ranges from 1 ns to 1 s. The electronic module adjusts the settings of the optical delay line located in the optical path of the control beam or the signal beam so that the signal measured by the photodetector is as small as possible. This ensures temporal synchronization between the signal beam and the control beam.

### Example 3

### Synchronization of the Signal Beam and Control Beam in the Detection of a Very Weak Optical Signal Modulated in the OOK Format Based on Quantum Pulse Gating

In the example shown in [FIG. 3], light pulses at frequency ω₁ (signal beam pulses) modulated in the OOK modulation format and propagating in many temporal-spectral modes are coupled into a nonlinear medium along with light pulses at frequency ω₂ (control beam pulses) in a selected single temporal-spectral mode. The control beam consists of a sequence of pulses in the selected temporal-spectral mode. The length of the optical carrier wave of the signal beam derived from frequency ω₁ is in the range of 700 nm- 1600 nm. Inside the nonlinear medium, the three-wave mixing occurs, where the pulses at frequency ω₁+ω₂ leaving the medium are in a single temporal-spectral mode determined by the mode of the control pulses, while the light beam of lower frequency leaving the medium contains the remaining temporal-spectral modes of the signal pulses. The output pulses of higher optical frequency are measured by a receiver adapted to detect optical signals modulated in the OOK format. The output pulses of lower optical frequency are monitored by a photodetector connected to an electronic module. The photodetector measures the time-averaged power of the optical signal and sends the measured value to the electronic module. The averaging time of the optical signal measured by the photodetector placed in the beam of lower optical frequency leaving the nonlinear medium ranges from 1 ns to 1 s. The electronic module adjusts the settings of the optical delay line located in the optical path of the control beam or the signal beam so that the signal measured by the photodetector is as small as possible. This ensures temporal synchronization between the signal beam and the control beam.

### Example 4

### Synchronization of the Signal Beam and Control Beam in the Detection of a Very Weak Optical Signal Carrying Quantum Information Based on Quantum Pulse Gating

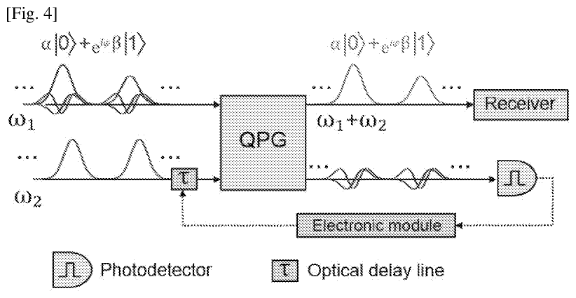

In the example shown in [FIG. 4], light pulses at frequency ω₁ (signal beam pulses) consist of time-encoded qubits. In this modulation method, a single quantum information qubit is encoded using a single photon in a superposition of two temporal-spectral modes. The length of the optical carrier wave of the signal beam derived from frequency ω₁ is in the range of 700 nm- 1600 nm. The optical signal is coupled into a nonlinear medium along with light pulses at frequency ω₂ (control beam pulses) in a selected single temporal-spectral mode. Inside the nonlinear medium, the three-wave mixing occurs, where the pulses at frequency ω₁+ω₂ leaving the medium are in a single temporal-spectral mode determined by the mode of the control pulses, while the beam of lower frequency leaving the medium contains the remaining temporal-spectral modes of the signal pulses. The output pulses of higher optical frequency are measured by a receiver adapted to detect time-encoded qubits. The output pulses of lower optical frequency are monitored by a photodetector connected to an electronic module. The photodetector measures the time-averaged power of the optical signal and sends the measured value to the electronic module. The electronic module adjusts the settings of the optical delay line located in the optical path of the control beam or the signal beam so that the signal measured by the photodetector is as small as possible. This ensures temporal synchronization between the signal beam and the control beam.

### Industrial Applicability

This invention is applicable in the satellite industry. It can be used by operators of Earth observation satellites or communication satellites in low-Earth orbits (LEO), which are capable of optical data transmission to an optical ground station. The invention can also be used by operators of space probes transmitting optical signals from deep space, such as the National Aeronautics and Space Administration (NASA), the European Space Agency (ESA), or the Japan Aerospace Exploration Agency (JAXA).

1. A method for synchronizing optical beams in the detection of very weak optical signals carrying classical or quantum information, based on quantum pulse gating implemented using a nonlinear optical medium, characterized in that the lower frequency optical beam leaving the nonlinear medium is monitored by a photodetector connected to an electronic module, the module controls the optical delay line placed in the optical path of either the control beam or the signal beam in such a way that the value of the time-averaged optical signal measured by the photodetector is as small as possible, while the correction of the delay line based on the measured signal occurs continuously or periodically, whereas the higher frequency optical beam leaving the nonlinear medium is measured using an optical signal receiver capable of detecting the optical signal modulated in the modulation format of the transmitter generating the signal beam pulses.

2. The method according to claim 1, characterized in that the photodetector monitoring the lower frequency optical beam leaving the nonlinear medium is either a photodiode or a single-photon detector.

3. The method according to claim 1 or 2, characterized in that the length of the optical carrier wave of the signal beam is in the range of 700 nm-1600 nm.

4. The method according to any of claims 1-3, characterized in that the signal beam is modulated in the PPM or OOK format.

5. The method according to any of claims 1-4, characterized in that the signal beam consists of single photons transmitted in a superposition of temporal-spectral or polarization modes.

6. The method according to any of claims 1-5, characterized in that the control beam consists of a sequence of pulses in a selected temporal-spectral mode.

7. The method according to any of claims 1-6, characterized in that the averaging time of the optical signal measured by the photodetector placed in the lower frequency optical beam leaving the nonlinear medium ranges from 1 ns to 1 s.
